(19) United States
(12) Patent Application Publication
(10) Pub. No.: US 2008/0239728 A1
(43) Pub. Date: Oct. 2, 2008

(54) LIGHT CONTROL DEVICE HAVING MODIFIED PRISM STRUCTURE

(76) Inventors: Tien-Hon CHIANG, Taipei (TW); Gu-Sheng Yu, Taipei (TW); Han-Ping Shieh, HsinChu (TW); Yi-Pai Huang, HsinChu (TW); Jen-Yu Fang, HsinChu (TW); Yu-Chun Lo, HsinChu (TW)

Correspondence Address: LEONG C LEI, PMB # 1008, 1867 YGNACIO VALLEY ROAD, WALNUT CREEK, CA, 94598, US

(21) Appl. No.: 11/691,502

(22) Filed: Mar. 27, 2007

(51) Int. Cl. F21V 5/02

(52) U.S. Cl. 362/339

(57) ABSTRACT

The light control device provides fillings in the valleys of the prism elements, be it uniformly or non-uniformly arranged, which is made of UV and/or thermal curable resins of an appropriate refractive index different from that of the prism elements. The optical performance of the original prism elements can be altered by the following approaches. First, the refractive index of the fillings can be appropriately chosen. Second, the fillings can be up to an appropriate height (but never overruns the surrounding prism elements). Third, the distribution of the height or the refractive index of the fillings across the light emission plane can be “patterned,” that is, in accordance with the planar light intensity distribution produced by the light source.

### BACKGROUND OF THE INVENTION

(a) Technical Field of the Invention

The present invention generally relates to light control devices, and more particularly to a light control device having an array of out-pointing prism elements on a major surface and, within the valleys of the prism elements, having fillings to alter the optical performance of the light control device.

(b) Description of the Prior Art

Prism sheets are a type of light control devices commonly found in backlight units of liquid crystal displays (LCDs) or LCD TVs. The light beams enter the prism sheet from a major surface of the prism sheet (hereinafter, the light incidence plane). On the other major surface of the prism sheet (hereinafter, the light emission plane), a number of aligned-in-parallel, out-pointing, triangular prism elements are configured, forming a series of interleaving peaks and valleys. The function of the prism elements is that, as shown in FIG. 1a, light beams (such as the light beam 30) passing through the light incidence plane 10 at an angle are refracted to leave the light emission plane 20 in a highly directed manner. On the other hand, light beams (such as the light beam 40) passing through the light incidence plane 10 perpendicularly or near perpendicularly are reflected back. As such, in a backlight unit, prism sheets are usually used along with a diffusion sheet which is positioned between light sources such as CCFL (cold cathode fluorescent lamp) tubes or light emitting diodes (LEDs) and the prism sheets. The diffusion sheet scatters or diffuses the light beams from the light sources to various directions and, then, the prism sheets focus or collimate the scattered light beams from the diffusion sheet into substantially parallel light beams within a specific viewing angle.

Many types of prism sheets have been disclosed in the prior arts. For example, both U.S. Pat. Nos. 4,542,449 and 4,791,540 teach prism sheets having uniform prism elements to form peaks (and valleys) of identical height (and depth). On the other hand, U.S. Pat. Nos. 5,919,551 and 5,771,328 teach prism sheets having non-uniform prism elements divided into zones or groups, and the prism elements in different zones or groups form peaks (and valleys) of different heights (and depths), as shown in FIG. 1b. The purpose of having variable peaks and valleys is to reduce the optical coupling or the visibility of moiré pattern when one or more prism sheets are used together.

As the prism sheets are most often used together with at least a diffusion sheet, there are also teachings about integrating the prism sheet and the diffusion sheet into a single light control device. FIGS. 1c and 1d are two possible embodiments of such integration where prism elements are arranged on the light emission plane 20 and diffusing elements are coated on the light incidence plane 10. The difference between FIGS. 1c and 1d lies in that the diffusing elements are uniformly disposed across the light incidence plate 10 in FIG. 1c while the diffusing elements in FIG. 1d, as taught by the U.S. patent application Ser. No. 11/272,905 filed by the present inventor, are “patterned” in accordance with a light intensity distribution produced by the light source.

### SUMMARY OF THE INVENTION

The primary purpose of the present invention is to obviate the constraint inherent in the conventional prism sheets. Regardless that the prism elements are uniformly or non-uniformly arranged, the energy of the light beams emanated from the prism sheet is confined within a certain range of viewing angles once the prism elements are set. If a different range of viewing angle is desired, a new prism sheet has to be designed, tested, and produced, all over again. With the present invention, a prism sheet can be tailored to deliver a modified optical performance, for example, to have an enlarged or reduced range of viewing angles.

To achieve the foregoing purpose, the present invention provides fillings in the valleys of the prism elements, be it uniformly or non-uniformly arranged, which is made of UV and/or thermal curable resins of appropriate refractive indices different from those of the prism elements. The optical performance of the original prism elements can be altered by the following approaches. First, the refractive indices of the fillings can be appropriately chosen. Second, the fillings can be up to certain heights (but never overruns the surrounding prism elements). Third, the distribution of the heights or the refractive indices of the fillings across the light emission plane can be “patterned,” that is, in accordance with a light intensity distribution produced by the light source.

Due to the difference of refractive indices at the interface between the fillings and the prism elements, the original range of viewing angles is enlarged or reduced. In addition, the degree of enlargement or reduction is strengthened (or lessened) as the fillings are close to (or distant from) the peaks of the prism elements. Further more, appropriate micro/nano particles or additives can be further blended into the fillings so that the fillings also deliver scattering or diffusing function.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1a is a schematic sectional view showing the trajectories of light beams in a conventional prism sheet with uniform prism elements.

FIG. 1b is a schematic sectional view showing a conventional prism sheet with non-uniform prism elements.

FIG. 1c is a schematic sectional view showing a conventional prism sheet having uniformly distributed diffusing elements along the light incidence plane.

FIG. 1d is a schematic sectional view showing a conventional prism sheet having non-uniformly distributed diffusing elements along the light incidence plane.

FIG. 2a is a schematic sectional view showing a light control device according to a first embodiment of the present invention where the fillings are uniform.

FIG. 2b is a schematic sectional view showing a light control device according to a second embodiment of the present invention where the heights of the fillings are patterned.

FIG. 2c is a schematic sectional view showing a light control device according to a third embodiment of the present invention where the refractive indices of the fillings are patterned.

FIG. 3a is a schematic sectional view showing a light control device according to a fourth embodiment of the present invention where a uniform distribution of diffusing elements is provided on the light incidence plane.

FIG. 3b is a schematic sectional view showing a light control device according to a fifth embodiment of the present invention where a patterned distribution of diffusing elements is provided on the light incidence plane.

FIG. 4a is a schematic sectional view showing a light control device according to a sixth embodiment of the present invention where the concentrations of the diffusing elements embedded in the fillings are uniformly distributed.

FIG. 4b is a schematic sectional view showing a light control device according to a seventh embodiment of the present invention where the concentrations of the diffusing elements embedded in the fillings are non-uniformly distributed.

FIG. 4c is a schematic sectional view showing a light control device according to an eighth embodiment of the present invention where the heights of the fillings having identical particle or additive concentrations are non-uniformly distributed.

FIG. 5 is a schematic sectional view showing a light control device according to a ninth embodiment of the present invention where the prism elements, the fillings, and the diffusing elements are all non-uniform.

FIG. 6a is a schematic side view showing an application scenario of a light control device of the present invention with a conventional edge-lit backlight unit.

FIG. 6b is a schematic side view showing another application scenario of a light control device of the present invention which is part of a conventional direct-lit backlight unit.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

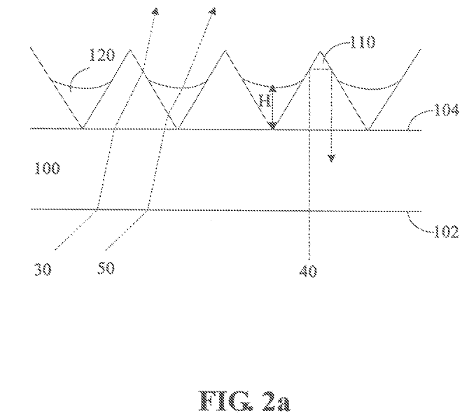

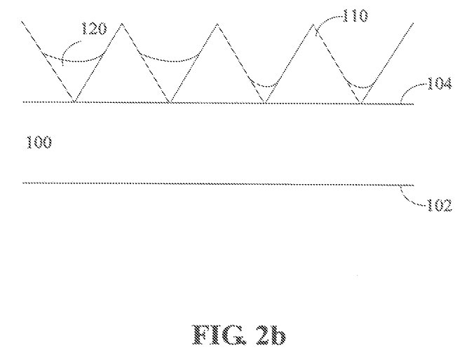

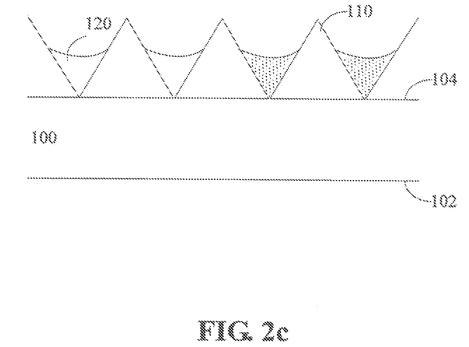

In the present invention, a light control device, such as the diffusion sheet and the prism sheet, manipulates, converts, or transforms the incident light beams in one way or another into having the desired optical characteristics. According to the present invention, the light control device, as shown in FIG. 2a, mainly contains a transparent polymer film or plate substrate 100 typically made of a material such as PET, PEN, PMMA, TAC, Polycarbonate, or the like. The light beams emanated from a light source (not shown) consisting of, for example, CCFL tubes or LEDs, enter and exit the light control device via the light incidence plane 102 and the light emission plane 104 of the substrate 100, respectively.

Along the light emission plane 104, a plurality of parallel and transparent prism elements 110 are provided and aligned along a first direction, thereby forming an array of interleaving peaks and valleys along a second direction perpendicular to the first direction. The present invention does not impose specific requirements on the geometric properties of the prism elements 110 such as their height, vertex angle, and bottom width, while the prism elements 110 are typically in the micrometer (i.e., 1˜10³ μm) or sub-micrometer (i.e., 1˜10⁻² μm) dimension. Further more, the present invention also does not require the prism elements 110 to be uniform (i.e., of identical shape, height, etc.). The geometric properties of the prism elements 110 could actually be randomly distributed or “patterned” to exhibit a specific distribution profile. More details about this will be explained later.

The substrate 100 and the prism elements 110 can be jointly obtained as a commercially off-the-shelf product such as the Vikuiti™ BEF film provided by 3M Company or the Diaart™ prism sheet provided by Mitsubishi Rayon Co., Ltd. Alternatively, the prism elements 110 can be formed as follows. First, a mold for the prism elements 110 is prepared before hand by machinery, lithographic, or MEMS methods. Then, resins having an appropriate refractive index, preferably in the range of 1.55˜1.75, are coated on the light emission plane 104 of the substrate 100 using flexography or micro gravure methods. Finally, the prism elements 110 are formed by embossment with UV/thermal curing. As such, the prism elements 110 are typically of the same refractive index. However, it is not unlikely to have prism elements 110 of different refractive indices by having several molds and by repeating the foregoing process to apply resins of different refractive indices in each run. Therefore, it has to be stressed again that the present invention does not require the prism elements 110 to have a specific refractive index, nor to have a uniform distribution of refractive indices. For the following description to the various embodiments of the present invention as well as the relevant drawings, it is assumed that the prism elements 110 are uniform both in terms of geometric properties and refractive indices for simplicity sake. Variations to the prism elements 110 will be described later in the present specification.

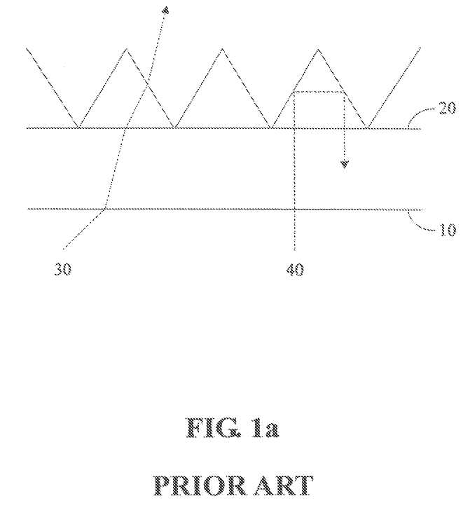

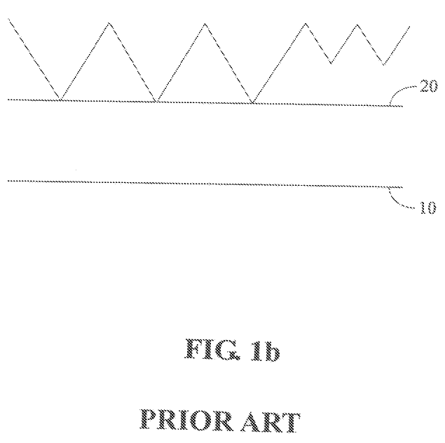

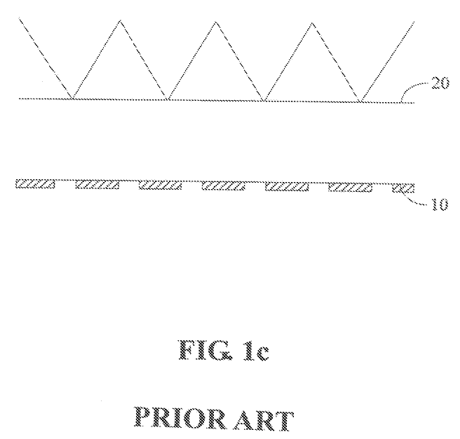

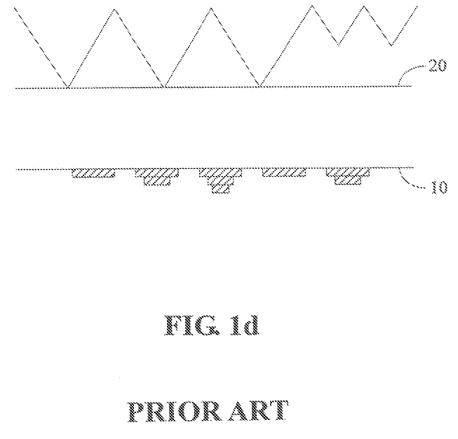

As shown in FIG. 2a, a first embodiment of the present invention fills the valleys of the prism elements 110 with resins having an appropriate refractive index or refractive indices (i.e., the fillings 120) different from that of the adjacent prism elements 110. Please note that, due to surface tension, the top surface of the fillings 120 are usually curved. It is because of the fillings 120 that the optical performance of the prism elements 110 is altered or modified. For the light beams 30 and 40 which exit the prism elements 110 directly to the air, their trajectories are exactly identical to what are shown in FIG. 1a. But for the light beam 50, which exits the prism elements 110 to the fillings 120, the difference of refractive indices between the prism elements 110 and the fillings 120 would cause the light beam 50 to bend differently, even though it has the same incidence angle to the substrate 100 as that of the light beam 30. As such, a first portion of the light beams (such as the light beams 30 and 40) would behave identically to when there are no fillings 120 provided. The rest second portion of the light beams (such as the light beam 50) would behave differently. As can be readily understood, the larger the difference in refractive indices between the prism elements 110 and the fillings 120, the greater the second portion of the light beams are bended.

The heights H of the fillings 120 should be always smaller than the depths of the valleys so that the fillings 120 will never overrun the adjacent prism elements 110. However, when the valleys are more filled to the top (i.e., the fillings 120 have a larger height H), a larger portion of the light beams will be affected, causing a greater degree of modification or alteration to the optical performance of the prism elements 110. Alternatively, if the valleys are less filled (i.e., the fillings 120 have a smaller height H), a smaller portion of the light beams will be affected, thereby delivering a lesser degree of modification or alternation to the optical performance of the prism elements 110.

FIGS. 2b and 2c shows a second and a third embodiment of the present invention. In contrast to the first embodiment where both the refractive indices and the heights of the fillings 120 are uniform across the light emission plane 104, the heights of the fillings 120 in the second embodiment of FIG. 2b and the refractive indices of the fillings 120 in the third embodiment of FIG. 2c are not uniform (the darker fillings 120 of FIG. 2c has a higher refractive index). They are referred to as “patterned” fillings in the present specification in that a feature ƒ of the fillings 120 (such as the heights and the refractive indices of the fillings 120) manifests a planar distribution ƒ(x, y) for all points (x, y) across a plane. More specifically, the feature ƒ of the fillings 120 (such as the heights and the refractive indices of the fillings 120) is configured in accordance with (i.e., having a functional relationship F with) a light intensity distribution e(x, y) produced by the light source (i.e., ƒ(x, y)=F(e(x, y))).

The purpose of having a patterned distribution is as follows. As it is difficult, if not impossible, to have a true planar light source, there are intensity differences among the light beams emanated from the light source. As the light beams shines on the light incidence plane 102, there will be areas along the light incidence plane 102 perceiving stronger light beams than other areas do. In other words, a light intensity distribution is developed across the light incidence plane 102 by the light source. As the light beams propagate to the light emission plane 104, they undergo the processing of the substrate 100, a related but somewhat different light intensity distribution is developed across the light emission plane 104. The light beams through the light emission plane 104 are further focused or collimated by the prism elements 110 to exhibit again a related but different light intensity distribution across the surfaces of the prism elements 110. Therefore, instead of having fillings 120 of equal heights and refractive indices to handle their incident light beams indiscriminately, the fillings 120 can have specific heights and/or specific refractive indices at specific valleys if the light beams emanated there have specific light intensities. Please note that patterned distributions of the heights and the refractive indices can be implemented separately as shown in FIGS. 2b and 2c, or they can be implemented together in the same embodiment. In addition to patterning the heights and indices of the fillings 120 against the light intensity distribution from the prism elements 110, the heights and indices can also be patterned against the light intensity distribution from the light emission plane 104, or the light intensity distribution from the light incidence plane 102, or even the light intensity distribution from the light source.

Please note that there are various ways to achieve the patterned distribution of the fillings 120. For example, a camera or CCD device is first used to capture an image of the prism elements 110 of the light control device. The image is then analyzed to derive the intensity distribution of the light beams from the prism elements 110. After this is done and appropriate molds are developed, the same manufacturing process outlined earlier are applied to fill the fillings 120 with appropriate refractive indices or to fill the fillings 120 to appropriate heights.

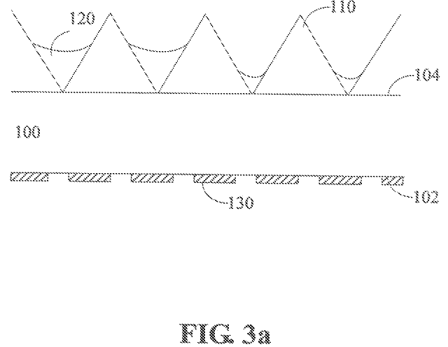

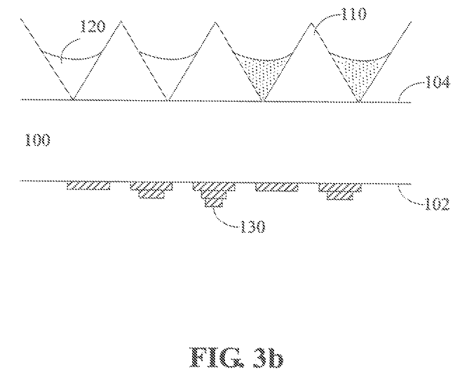

FIG. 3a is a schematic sectional view showing a fourth embodiment of the present invention where a uniform distribution of diffusing elements 130 is provided on the light incidence plane 102. The diffusing elements 130 are formed by coating an appropriate coating material on the light incidence plane 102 of the substrate 110 using flat plate or roll to roll printing to achieve a uniform degree of haze or surface roughness along the light incidence plane 102. The coating material includes, but is not limited to, UV and/or thermal curable resins which contain micro/nano particles or additives to scatter the light. Similarly, the distribution of the diffusing elements 130 (and, therefore, the degree of haze or surface roughness) can also be patterned in accordance with the light intensity distribution from the light incidence plane 102 or from the light source, as in a fifth embodiment of the present invention shown in FIG. 3b. To achieve the patterned distribution of diffusing elements 130, appropriate masks are derived from an analysis of the light intensity distribution of the light incidence plane 102 or the light source. The masks are then applied in the aforementioned flat plate or roll to roll printing to obtain a non-uniform distribution of the diffusing elements 130 (and, therefore, a non-uniform distribution of the degree of haze or surface roughness). Please note that the uniform or patterned distribution of the diffusing elements 130 can be implemented separately or jointly with the implementation of the uniform or patterned distribution of the fillings 120.

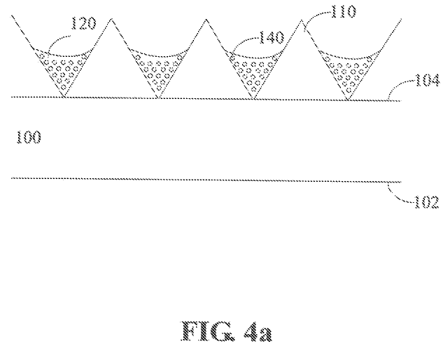

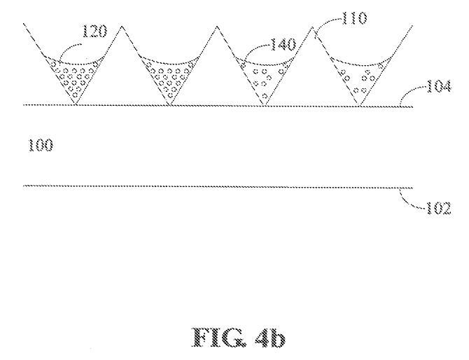

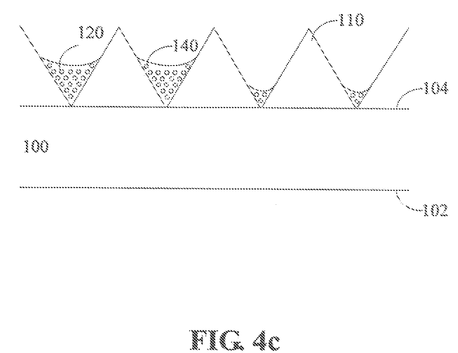

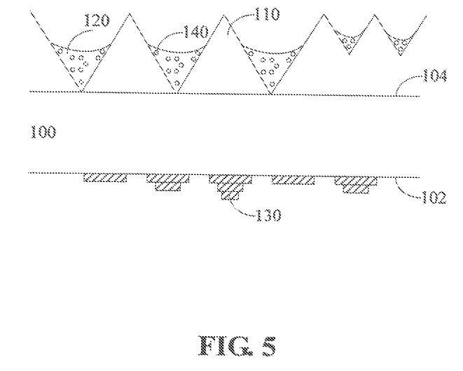

Instead of having a separate layer of diffusing elements 130 as shown in FIGS. 3a and 3b, alternative embodiments of the present invention can further integrate the scattering or diffusing function of the diffusing elements 130 into the fillings 120. As shown in FIG. 4a, which depicts the sixth embodiment of the present invention, a number of micro/nano particles or additives 140 are blended in the resins that constitute the fillings 120. The concentration of the micro/nano particles or additives 140 among the fillings 120 is substantially uniform across the light emission plane 104 in FIG. 4a. However, as in previous embodiments, the distribution of particle or additive concentration can also be patterned, as shown in the seventh embodiment of the present invention shown in FIG. 4b, in accordance with the light intensity distribution from the prism elements 110, the light intensity distribution from the light emission plane 104, or the light intensity distribution from the light incidence plane 102, or even the light intensity distribution from the light source. FIG. 4c depicts an eighth embodiment of the present invention which is a combination of the previous embodiments. As the diffusing or scattering function of the fillings 120 with identical particle or additive concentrations would also vary as the heights of the fillings 120 differ. That is, as the fillings 120 are higher, the diffusing or scattering function would be stronger with the increased number of particles or additives 140. Therefore, as shown in FIG. 4c, the distribution of the heights of the fillings 120 having identical concentrations of particles or additives can be patterned in accordance with the light intensity distribution from the prism elements 110, the light intensity distribution from the light emission plane 104, or the light intensity distribution from the light incidence plane 102, or even the light intensity distribution from the light source. Please note that the uniform or patterned distribution of the concentrations of the particles or additives 140 or the heights of the fillings 120 can be implemented separately or jointly with the implementation of the uniform or patterned distribution of the fillings 120. Having described the foregoing embodiment, the present invention does not preclude the joint implementation of embedding the particles or additives 140 into the fillings 120, be it uniform or patterned, and having diffusing elements 130 on the light incidence plane 102, be it uniform or patterned. FIG. 5, for example, is one such combination. More details about FIG. 5 will be given later.

As mentioned earlier, for simplicity sake, the foregoing embodiment of the present invention assumes that the prism elements 110 are uniformly distributed in terms of their geometric properties or refractive indices. However, it is also possible to have one or more of the geometric properties or the refractive indices of the prism elements 110 patterned in accordance with the light intensity distribution from the light emission plane 104, or the light intensity distribution from the light incidence plane 102, or even the light intensity distribution from the light source, as shown in FIG. 5. In addition, the uniform or patterned distribution of the geometric properties or refractive indices of the prism elements 110 can be implemented separately or jointly with the uniform or patterned distributions of the fillings 120, the particles or additives 140, and/or the diffusing elements 130.

Some final notes to the present invention. First, so far the present invention has been specified that the prism elements 110 are always positioned along the light emission plane 104. However, in some special applications, the light control device is actually flipped 180 degrees so that the prism elements 110, instead of pointing away from, point towards the light source. As such, using the light control device of FIG. 3a as example, the light beams of the light source are actually collimated first by the prism elements 110 and then scattered by the diffusing elements 130. In other words, the principles of the present invention are still applicable to light control devices where the prism elements are positioned along the light incidence plane. In abstract terms, a light control device according to the present invention should have two opposing major surfaces, where the prism elements are positioned along one of the two major surfaces, and the light beams of a light source enters and exits the light control device through the major surfaces, respectively.

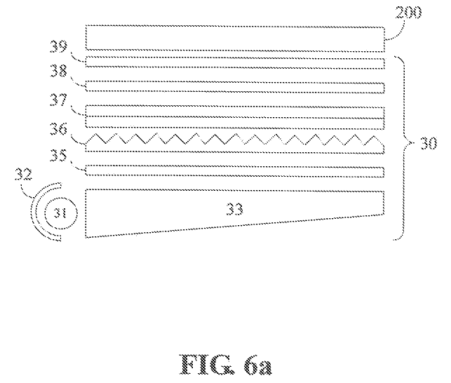

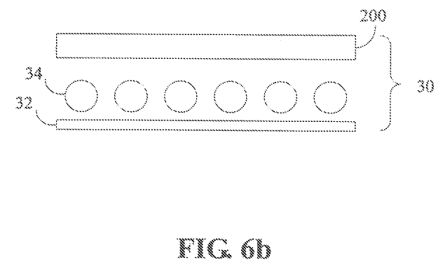

Secondly, the present specification has been referring to a light source as the origin of light beams manipulated by the light control device of the present invention. The term “light source” is used here abstractly. For example, FIG. 6a is a schematic side view showing an application scenario of the light control device 200 of the present invention with a conventional edge-lit backlight unit 30. As shown in FIG. 6a, the entire backlight unit 30 is considered a “light source” where light beams emitted from a CCFL tube 31 is directed into a side of a light guide plate 33 with the help of a reflector 32 and then redirected to the light control device 40. The backlight unit 30 further contains a diffusion sheet 35 for scattering the light from the light guide plate 33, two prism sheets 36 and 37 whose respective prism elements are aligned orthogonally for focusing the scattered light from the diffusion sheet 35 into substantially parallel light beams, an optional polarization or anti-reflection film or layer 38, and another diffusion sheet 39 to achieve further intensity uniformity of the light beams. As another example, FIG. 6b is a schematic side view showing another application scenario of the light control device 200 of the present invention. As shown in FIG. 6b, multiple LEDs 34 of the backlight unit 30 are arranged in front of the reflector 32 so as to direct light all toward the light control device 200. In this scenario, the light control device 200 is actually a part of the direct-lit backlight unit 30 where, to the light control device 200, the light source is the combination of LEDs 34 and the reflector 32.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light control device, comprising:
a transparent substrate having a first major surface and a second major surface opposing to said first major surface, wherein the light beams from a light source entering said transparent substrate through one of said first and said second major surfaces and exiting said transparent substrate through the other major surface;
a plurality of transparent and parallel prism elements on said first major surface forming an array of interleaving peaks and valleys; and
a plurality of transparent fillings provided in said valleys, the heights of said fillings being such that said fillings do not overrun the adjacent prism elements.

2. The light control device according to claim 1, wherein the refractive indices of said fillings are different from those of the adjacent prism elements.

3. The light control device according to claim 1, further comprising a plurality of diffusing elements on said second major surface, delivering a planar distribution of the degree of haze across said second major surface.

4. The light control device according to claim 3, wherein said planar distribution of the degree of haze is patterned in accordance with the planar light intensity distribution from one of said light source and said second major surface.

5. The light control device according to claim 1, wherein said prism elements have a planar distribution of geometric properties in accordance with the planar light intensity distribution from one of said light source, said second major surface, and said first major surface.

6. The light control device according to claim 1, wherein said prism elements have a planar distribution of refractive indices in accordance with the planar light intensity distribution from one of said light source, said second major surface, and said first major surface.

7. The light control device according to claim 1, wherein said fillings have a planar distribution of heights in accordance with the planar light intensity distribution from one of said light source, said second major surface, said first major surface, and said prism elements.

8. The light control device according to claim 1, wherein said fillings have a planar distribution of refractive indices in accordance with the planar light intensity distribution from one of said light source, said second major surface, said first major surface, and said prism elements.

9. The light control device according to claim 1, wherein a plurality of micro/nano particles are blended in said fillings.

10. The light control device according to claim 9, wherein said fillings have a planar distribution of the particle concentration in accordance with the planar light intensity distribution from one of said light source, said second major surface, said first major surface, and said prism elements.

11. The light control device according to claim 9, wherein said fillings have a planar distribution of heights in accordance with the planar light intensity distribution from one of said light source, said second major surface, and first major surface, and said prism elements.

12. The light control device according to claim 1, wherein said light control device and said light source are parts of a backlight unit.

13. The light control device according to claim 1, wherein said light source is a backlight unit.
